(19) United States
(12) Patent Application Publication
(10) Pub. No.: US 2014/0063823 A1
(43) Pub. Date: Mar. 6, 2014

(54) LIGHTING APPARATUS

(71) Applicants: Ryuya Miwa, Osaka (JP); Ryota Suzuki, Osaka (JP)

(72) Inventors: Ryuya Miwa, Osaka (JP); Ryota Suzuki, Osaka (JP)

(73) Assignee: PANASONIC CORPORATION, Osaka (JP)

(21) Appl. No.: 14/115,157

(22) PCT Filed: May 9, 2012
(86) PCT No.: PCT/JP2012/003038

§ 371 Date: Nov. 1, 2013

(30) Foreign Application Priority Data
May 13, 2011 (JP) 2011-108169

(51) Int. Cl. F21V 21/088

(52) U.S. Cl. CPC F21V 21/088
USPC 362/396

(57) ABSTRACT

A lighting apparatus includes an apparatus body, an LED unit including an LED substrate, and a fixing member which attaches the LED substrate to a bottom surface of the apparatus body. The fixing member has elasticity and includes: a fixing claw having a flat plate, which protrudes in a planar direction and which presses the LED substrate against the bottom surface of the apparatus body; and a positioning claw having an L-shape, which protrudes in the planar direction and which contacts at least one side of the LED substrate in the planar direction.

### TECHNICAL FIELD

The present invention relates to a lighting apparatus which is applicable, for example, to a downlight installed into a storing hole opened in a ceiling material.

### BACKGROUND ART

In a known lighting apparatus, a screw is screwed into an LED substrate, whereby a reflection plate is pulled toward an apparatus body. Consequently, the LED substrate is pressed toward a partition plate by the reflection plate, thereby being fixed to the apparatus body (see, for example, Patent Document 1).

### RELATED ART DOCUMENTS

### Patent Documents

Patent Document 1: JP-A-2008-204692 (FIG. 2, paragraph 0067)

### SUMMARY OF THE INVENTION

### Problem to be Solved by the Invention

However, the lighting apparatus of Patent Document 1 does not include means for positioning the LED substrate at a predetermined position of the apparatus body. Therefore, the LED substrate cannot be easily positioned at the predetermined position on the apparatus body.

Accordingly, assembling workability of the lighting apparatus of Patent Document 1 for positioning and fixing the LED substrate at the predetermined position on the apparatus body is not high.

In Patent Document 1, when the LED substrate is not placed at the predetermined position on the apparatus body, an optical characteristic may be deteriorated.

Further, in Patent Document 1, the LED substrate is fixed to the apparatus body by only screw-in force of screws.

Therefore, in Patent Document 1, pressing force exerted on the LED substrate becomes unstable depending on a screw-in amount of the screw.

The invention has been made in order to solve the above-described problems, and an object thereof is to provide a lighting apparatus which can improve assembling workability of an LED substrate and which can stably fix the LED substrate.

### Means for Solving the Problem

A lighting apparatus of the invention includes: an apparatus body formed to have a substantially C-shape; an LED unit comprising an LED substrate; and a fixing member which attaches the LED substrate to a bottom surface of the apparatus body, and the fixing member has elasticity and includes: a fixing claw having a flat plate shape, which protrudes in a planar direction and which presses the LED substrate against the bottom surface of the apparatus body; and a positioning claw having an L-shape, which protrudes in the planar direction and which contacts at least one side of the LED substrate in the planar direction.

### Advantages of the Invention

The lighting apparatus according to the present invention can provide advantages of improving the assembling workability of the LED substrate and stably fixing the LED substrate.

### BRIEF DESCRIPTION OF THE DRAWINGS

FIG. 1 is an external perspective view of a lighting apparatus according to a first embodiment of the invention, as viewed from an obliquely upward position.

FIG. 2 is a cross-sectional perspective view of the lighting apparatus according to the first embodiment of the invention.

FIG. 3 is a bottom view of an apparatus body of the lighting apparatus according to the first embodiment of the invention.

FIG. 4 is an external perspective view of an LED substrate and in the vicinity thereof during work, showing a state in which the apparatus body of the lighting apparatus according to the first embodiment of the invention is turned upside down.

FIG. 5 is an enlarged external perspective view of the LED substrate and in the vicinity thereof during work, showing a state in which the apparatus body of the lighting apparatus according to the first embodiment of the invention is turned upside down.

FIG. 6 is an external perspective view of an LED substrate and in the vicinity thereof during work, showing a state in which an apparatus body of a lighting apparatus according to a second embodiment of the invention is turned upside down.

FIG. 7 is an enlarged external perspective view of the LED substrate and in the vicinity thereof during work, showing a state in which the apparatus body of the lighting apparatus according to the second embodiment of the invention is turned upside down.

### MODE FOR CARRYING OUT THE INVENTION

A lighting apparatus according to each of a plurality of embodiments of the invention is hereunder described with reference to the drawings.

### First Embodiment

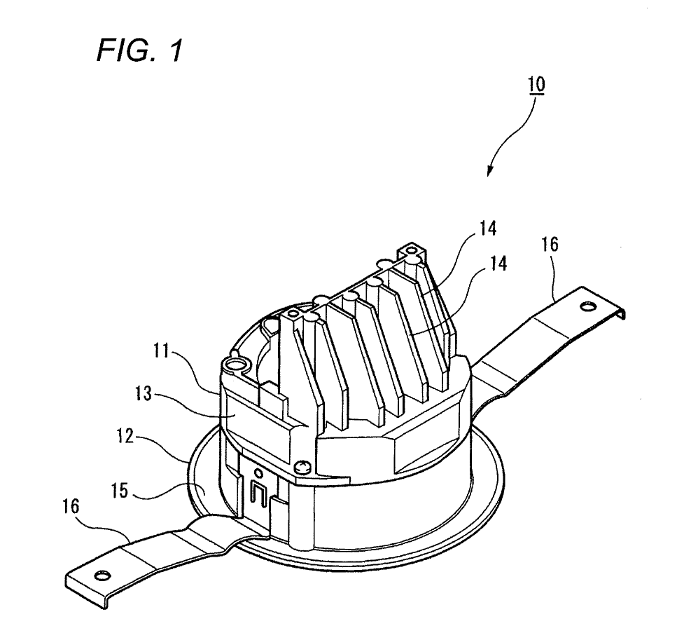

As shown in FIG. 1, a lighting apparatus 10 according to a first embodiment of the invention includes an apparatus body 11 and a frame body 12 attached below the apparatus body 11, and is applicable, for example, to a downlight installed in a storing hole opened in a ceiling material (not shown).

The apparatus body 11 is made of metal such as an aluminum die casting, and includes a substantially cylindrical tubular portion 13 and a plurality of heat radiation fins 14 provided on an upper portion of the tubular portion 13.

A power unit (not shown) is attached outside the apparatus body 11 by a bracket (not shown).

The frame body 12 is molded for example, from a hard resin material. The frame body 12 includes: a flange-shaped decorative laminate 15 provided at a lower end of the frame body 12; and a pair of mounting springs 16 attached to positions on opposing sides of the frame body 12.

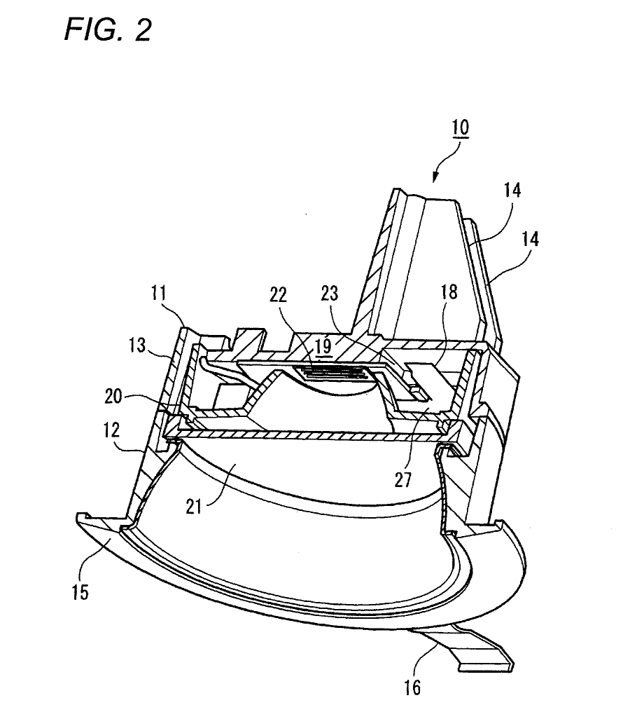

As shown in FIG. 2, the lighting fixture 10 includes an LED unit 19 attached to a lower surface of a bottom plate 17 of the apparatus body 11 by a fixing member 18.

The lighting apparatus 10 further includes: a reflection plate 20 attached at a position immediately below the LED unit 19; and a translucent white or transparent lens 21 attached ahead of the reflection plate 20.

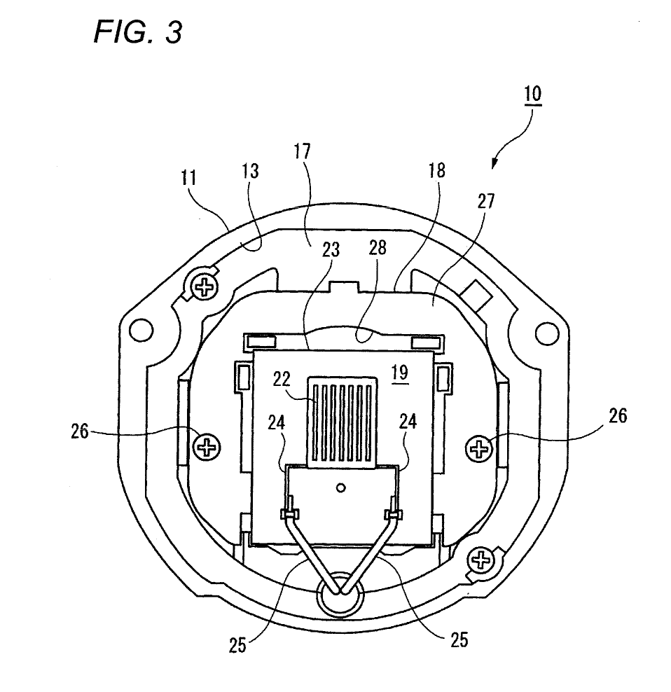

The LED unit 19 includes a rectangular phosphor layer 22 having a predetermined thickness which is sealed on a front surface of an LED substrate 23; and printed circuits 24 (see FIG. 3) formed on the LED substrate 23 and electrically connected to the power unit by lead wires 25 (see FIG. 3).

As shown in FIG. 3, the LED substrate 23 is attached to a predetermined position on the bottom plate 17 of the apparatus body 11 by screwing a pair of screws 26 into the fixing member 18 having a C-shape and a plate shape.

In the LED substrate 23, the lead wires 25 drawn out from the bottom plate 17 of the apparatus body 11 are soldered to the printed circuits 24.

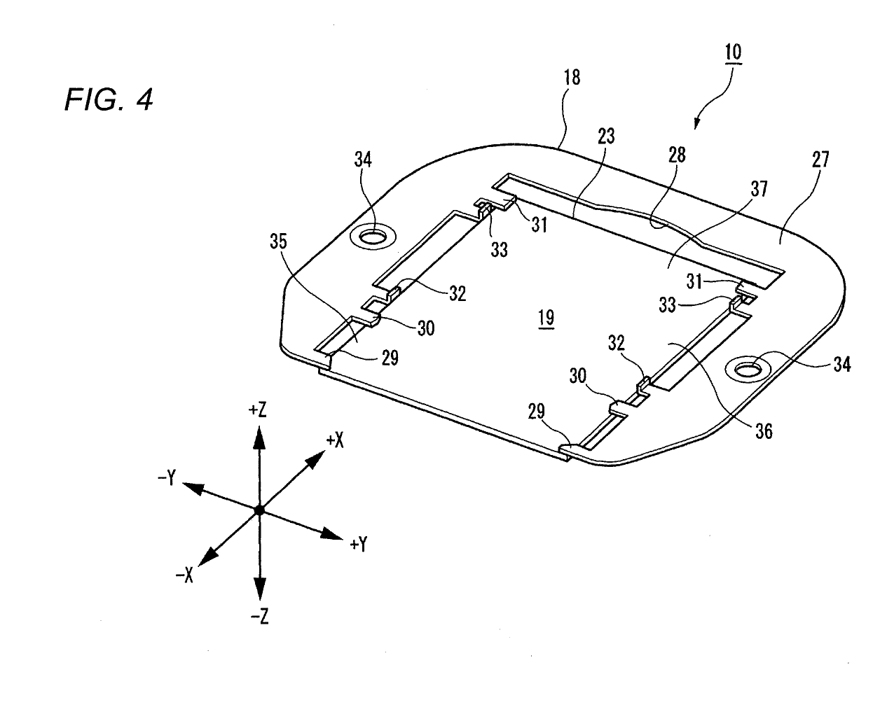

As shown in FIG. 4, the LED substrate 23 is formed into a rectangular plate shape having a given thickness.

The fixing member 18 is formed into a C-shape by an elastic metallic plate member, and includes a main body 27 and an LED substrate accommodation portion 28 on an inner side of the main body 27.

The fixing member 18 includes a pair of first fixing claws 29 which oppose each other. The first fixing claws 29 have a flat plate shape, which extend from both end portions of an open side of the LED substrate accommodation portion 28 in a planar direction of the main body 27 to protrude in −Y and +Y directions in FIG. 4.

Each of the first fixing claws 29 is sufficiently longer than a distance between the LED substrate 23 placed in the LED substrate accommodation portion 28 and a corresponding side edge of the LED substrate accommodation portion 28.

The fixing member 18 includes a pair of second fixing claws 30 which oppose each other. The second fixing claws 30 have a flat plate shape, which extend from center portions of the LED substrate accommodation portion 28 in the planar direction of the main body 27 to protrude in the −Y and +Y directions in FIG. 4.

Each of the second fixing claws 30 is sufficiently longer than a distance between the LED substrate 23 placed in the LED substrate accommodation portion 28 and a corresponding side edge of the LED substrate accommodation portion 28.

The fixing member 18 includes a pair of third fixing claws 31 which oppose each other. The third fixing claws 31 have a flat plate shape, which extend from both end portions of a closed side of the LED substrate accommodation portion 28 in the planar direction of the main body 27 to protrude in the −Y and +Y directions in FIG. 4.

Each of the third fixing claws 31 is sufficiently longer than a distance between the LED substrate 23 placed in the LED substrate accommodation portion 28 and a corresponding side edge of the LED substrate accommodation portion 28.

The fixing member 18 includes a pair of first positioning claws 32 which oppose each other. The first positioning claws 32 have an L-shape, which extend from portions in the vicinity of the respective second fixing claws 30 in the planar direction of the main body 27 toward the interior of the LED substrate accommodation portion 28 to protrude in the −Y and +Y directions in FIG. 4.

Each of the first positioning claws 32 is slightly shorter than a distance between the LED substrate 23 placed in the LED substrate accommodation portion 28 and a corresponding side edge of the LED substrate accommodation portion 28.

The fixing member 18 includes a pair of second positioning claws 33 which oppose each other. The second positioning claws 33 have an L-shape, which extend from portions in the vicinity of the respective third fixing claws 31 in the planar direction of the main body 27 toward the interior of the LED substrate accommodation portion 28 to protrude in the −Y and +Y directions in FIG. 4.

Each of the second positioning claws 33 is slightly shorter than a distance between the LED substrate 23 placed in the LED substrate accommodation portion 28 and a corresponding side edge of the LED substrate accommodation portion 28.

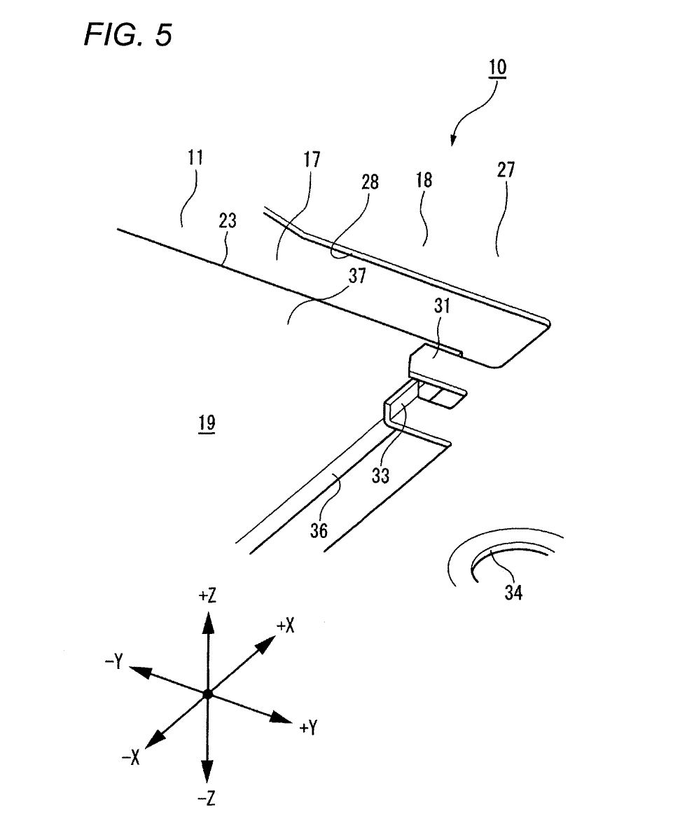

As shown in FIG. 5, the fixing member 18 has a pair of screw holes 34 which allows the respective screws 26 to be inserted therein. Each of the screw holes 34 is formed to have a distance from the second fixing claw 30 equal to a distance from the third fixing claw 31.

For this reason, when the screws 26 are inserted into the respective screw holes 34 and screwed into the bottom plate 17 of the apparatus body 11, screw-in stress evenly acts on the second fixing claws 30 and the third fixing claws 31.

The second positioning claws 33 are bent toward a +Z direction in FIGS. 4 and 5 to have the L-shape.

Therefore, when the fixing member 18 is screwed to the bottom plate 17 of the apparatus body 11, the second positioning claws 33 contact a side surface 35 of the LED substrate 23 on a Y direction side in FIG. 5 and a side surface 36 of the LED substrate 23 on the +Y direction side in FIG. 5.

Similar to the second positioning claws 33, the first positioning claws 32 are bent toward a +Z direction in FIG. 4 to have the L-shape.

Accordingly, when the fixing member 18 is screwed to the bottom plate 17 of the apparatus body 11, the first positioning claws 32 contact the side surface 35 of the LED substrate 23 on the −Y direction side in FIG. 4 and the side surface 36 of the LED substrate 23 on the +Y direction side in FIG. 4.

Procedures for attaching the LED substrate 23 by the fixing member 18 will be described.

First, the LED substrate 23 is placed on the bottom plate 17 of the apparatus body 11. At this time, the LED substrate 23 has not positioned yet.

The fixing member 18 is then put on the LED substrate 23 from above.

The first fixing claws 29, the second fixing claws 30, and the third fixing claws 31 are sufficiently longer than the distance between the LED substrate 23 and the corresponding side edge of the LED substrate accommodation portion 28.

Consequently, the first fixing claws 29, the second fixing claws 30, and the third fixing claws 31 are placed on an upper surface 37 of the LED substrate 23.

At this time, the fixing member 18 is in a state in which the main body 27 is spaced from the bottom plate 17 of the apparatus body 11.

For this reason, the first positioning claws 32 and the second positioning claws 33 do not contact the side surface 35 of the LED substrate 23 on the −Y direction side in FIG. 5 and the side surface 36 of the LED substrate 23 on the +Y direction side in FIG. 5.

Next, the screws 26 are inserted into the respective screw holes 34 of the fixing member 18, and the screws 26 are screwed into the bottom plate 17 of the apparatus body 11.

By screwing the screws 26 into the bottom plate 17 of the apparatus body 11, the main body 27 of the fixing member 18 is moved in a −Z direction in FIG. 5 toward the bottom plate 17 of the apparatus body 11.

Thus, the first fixing claws 29, the second fixing claws 30, and the third fixing claws 31 placed on the upper surface 37 of the LED substrate 23 are elastically deformed.

By elastic repulsive force accumulated in the first fixing claws 29, the second fixing claws 30, and the third fixing claws 31, the LED substrate 23 is pressed toward the bottom plate 17 of the apparatus body 11 in the −Z direction in FIG. 5.

Since the main body 27 of the fixing member 18 approaches the bottom plate 17 of the apparatus body 11, the first positioning claws 32 and the second positioning claws 33 are moved toward the bottom plate 17 of the apparatus body 11.

For this reason, the first positioning claws 32 and the second positioning claws 33 contact the side surface 35 of the LED substrate 23 on the −Y direction side in FIG. 5 and the side surface 36 of the LED substrate 23 on the +Y direction side in FIG. 5, respectively.

The first fixing claws 29, the second fixing claws 30, and the third fixing claws 31 press the upper surface 37 of the LED substrate 23 toward the bottom plate 17 of the apparatus body 11.

In this state, the first positioning claws 32 and the second positioning claws 33 support the side surface 35 of the LED substrate 23 on the −Y direction side in FIG. 5 and the side surface 36 of the LED substrate 23 on the +Y direction side in FIG. 5, respectively.

Accordingly, the LED substrate 23 can simply be fixed to the predetermined position on the bottom plate 17 of the apparatus body 11 by mounting the fixing member 18.

The LED substrate 23 can stably be fixed to the bottom plate 17 of the apparatus body 11 by mounting the fixing member 18.

The LED substrate 23 is brought into close contact with and thermally connected to the bottom plate 17 of the apparatus body 11 by mounting the fixing member 18.

The lighting apparatus 10 is installed by inserting the apparatus body 11 into the storing hole of the ceiling material from below while the mounting springs 16 are elastically deformed so as to extend along the apparatus body 11.

The mounting springs 16 are elastically restored in a horizontal direction after the apparatus body 11 has been inserted into the storing hole of the ceiling material, whereby the apparatus body 11 is supported on the ceiling material, and the lighting apparatus 10 is installed on a ceiling surface.

In the above-described lighting apparatus 10 according to the first embodiment of the invention, the LED substrate 23 can simply, stably be fixed to the predetermined position on the bottom plate 17 of the apparatus body 11 by attachment of the fixing member 18.

In the lighting apparatus 10 of the first embodiment, the LED substrate 23 is brought into close contact with and thermally connected to the bottom plate 17 of the apparatus body 11 by attachment of the fixing member 18. Therefore, a heat dissipation path of the LED substrate 23 can be assured.

### Second Embodiment

A lighting apparatus according to a second embodiment of the invention will be described.

In the second embodiment, elements overlapping with or functionally similar to the elements in the first embodiment are assigned the same or corresponding reference numerals in the drawings, and their explanations are simplified or omitted.

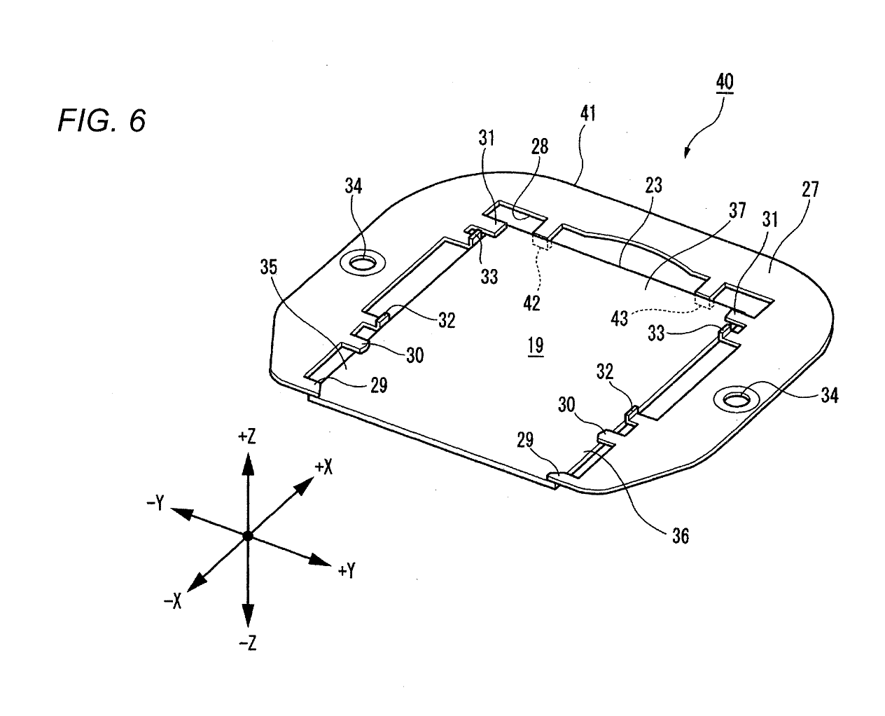

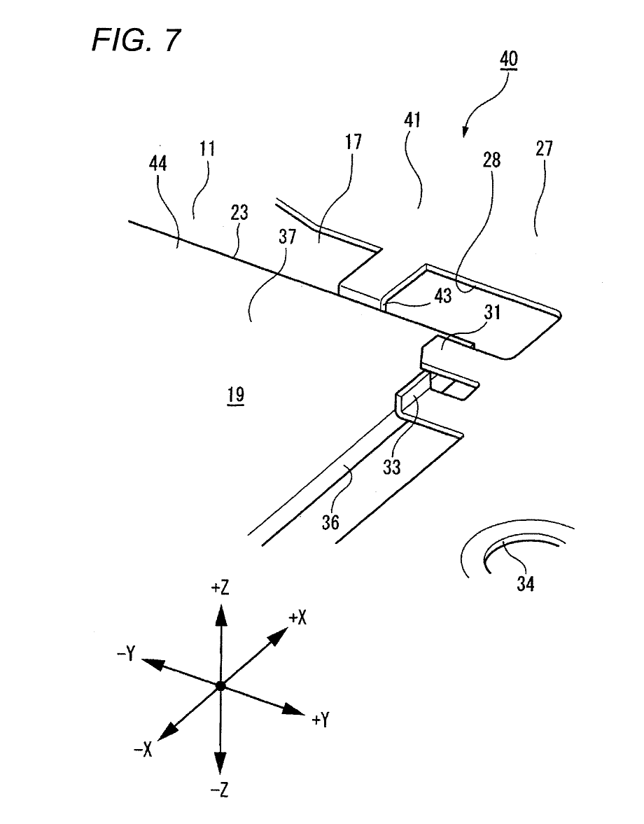

As shown in FIGS. 6 and 7, a lighting apparatus 40 according to the second embodiment of the invention includes a fixing member 41 which includes a third positioning claw 42 and a fourth positioning claw 43 in addition to the first fixing claws 29, the second fixing claws 30, the third fixing claws 31, the first positioning claws 32, and the second positioning claws 33.

The third positioning claw 42 is slightly shorter than a distance between the LED substrate 23 placed in the LED substrate accommodation portion 28 and the side edge of the LED substrate accommodation portion 28.

The third positioning claw 42 is placed at a position deviated from the center in the −Y direction shown in FIG. 6 on the LED substrate accommodation portion 28 which corresponds to a side surface 44 perpendicular to the side surfaces 35 and 36 of the LED substrate 23.

Since the third positioning claw 42 is bent in the −Z direction shown in FIGS. 6 and 7 to have the L-shape, the third positioning claw 42 contacts the side surface 44 of the LED substrate 23 when the fixing member 18 is screwed to the bottom plate 17 of the apparatus body 11.

The fourth positioning claw 43 is slightly shorter than the distance between the LED substrate 23 placed in the LED substrate accommodation portion 28 and the side edge of the LED substrate accommodation portion 28.

The fourth positioning claw 43 is placed at a position deviated from the center in the +Y direction shown in FIG. 6 on the LED substrate accommodation portion 28 which corresponds to the side surface 44 perpendicular to the side surfaces 35 and 36 of the LED substrate 23.

Since the fourth positioning claw 43 is bent in the −Z direction shown in FIG. 6 and FIG. 7 to have the L-shape, the fourth positioning claw 43 contacts the side surface 44 of the LED substrate 23 when the fixing member 18 is screwed to the bottom plate 17 of the apparatus body 11.

In the lighting apparatus 40 according to the second embodiment of the invention, the three side surfaces 35, 36, 44 of the LED substrate 23 are supported and positioned by the fixing member 41, whereby positioning accuracy can be further improved.

In the lighting apparatus of the invention, the apparatus body, the frame body, the lens, the mounting springs, etc., are not limited to those described in the embodiments and may appropriately be modified or improved.

This application is based on Japanese Patent Application (Application No. 2011-108169) filed on May 13, 2011, contents of which are incorporated herein by reference.

### DESCRIPTION OF REFERENCE SIGNS

10, 40: Lighting Apparatus
11: Apparatus Body
18, 41: Fixing Member
19: LED Unit
23: LED Substrate
29: First Fixing Claw (Fixing Claw)
30: Second Fixing Claw (Fixing Claw)
31: Third Fixing Claw (Fixing Claw)
32: First Positioning Claw (Positioning Claw)
33: Second Positioning Claw (Positioning Claw)
42: Third Positioning Claw (Positioning Claw)
43: Fourth Positioning Claw (Positioning Claw)

1. A lighting apparatus comprising:
an apparatus body formed to have a substantially C-shape;
an LED unit comprising an LED substrate; and
a fixing member which attaches the LED substrate to a bottom surface of the apparatus body,
wherein the fixing member has elasticity and comprises:
a fixing claw having a flat plate shape, which protrudes in a planar direction and which presses the LED substrate against the bottom surface of the apparatus body; and
a positioning claw having an L-shape, which protrudes in the planar direction and which contacts at least one side of the LED substrate in the planar direction.
